(19) United States
(12) Patent Application Publication
(10) Pub. No.: US 2026/0340239 A1
(43) Pub. Date: Oct. 29, 2026

(54) SYSTEM FOR CONTROLLING FLUID SPATIAL FIELD IN FURNACE BASED ON LARGE MODEL

(71) Applicant: North China Electric Power University, Beijing (CN)

(72) Inventors: Fang FANG, Beijing (CN); Zhuotong LUO, Beijing (CN); Yun JU, Beijing (CN); Le WEI, Beijing (CN); Yi ZHANG, Beijing (CN); Songyuan YU, Beijing (CN); Qi YAO, Beijing (CN); Jinze LI, Beijing (CN); Junhong WU, Beijing (CN)

(21) Appl. No.: 19/325,933

(22) Filed: Sep. 11, 2025

(30) Foreign Application Priority Data
Apr. 24, 2025 (CN) 202510526258.3

(51) Int. Cl. G06F 30/28

(52) U.S. Cl. CPC G06F 30/28

(57) ABSTRACT

Provided is a system for controlling a fluid spatial field in a furnace based on a large model, which relates to the field of fluid spatial field control. The system is provided with a distributed sensor network, a data acquisition device, a distributed storage device and an edge computing device. A small prediction model and a large modification model are deployed on the edge computing device, the small prediction model is used for prediction, and the large modification model is used for modification of a prediction result, so that precision and stability of prediction are improved. Prediction of the fluid spatial field in the furnace is completed based on fluid spatial field data measured by a finite number of sensors in the furnace, and control of the fluid spatial field in the furnace is carried out based on the prediction result.

### CROSS-REFERENCE TO RELATED PRESENT DISCLOSURE

This application claims the benefit of and priority to Chinese Patent Application No. 202510526258.3 filed Apr. 24, 2025, which is hereby incorporated by reference herein in its entirety.

### TECHNICAL FIELD

The present disclosure relates to the field of fluid spatial field control, in particular to a system for controlling a fluid spatial field in a furnace based on a large model.

### BACKGROUND

Fast and accurate prediction of the fluid spatial field is very important for understanding a fluid change trend and optimizing a production process. However, due to the cost and complexity of operation, the comprehensive deployment of a physical sensor in most fluid spaces is limited, so that researchers usually rely on a numerical calculation method to simulate the flow features of the fluid spatial field. For example, Navier-Stokes (NS) equation, as a partial differential equation describing hydrodynamic features, is suitable for some simple flow scenarios, but there is a contradiction between efficiency and precision in solving most complex fluid flow problems. A conventional turbulence modeling method faces many challenges, such as limited precision, long calculation time and huge consumption of calculation resources, which limit effectiveness and universality in practical application.

Among the existing research methods, it is a common solution to calculate the flow field and simulate the space physical field based on Ansys Fluent. Ansys Fluent is a widely used Computational Fluid Dynamics (CFD) software package, which has an advanced numerical calculation method and a powerful preprocessor and postprocessor functions, and can be used for professional analysis of fluid dynamics, a heat transfer process, a combustion process and a multiphase flow process. However, this method relies on the dynamic solution of the spatial field information and uses an iterative calculation form, which leads to a high consumption of computing resources and the limitation that it is difficult to extend to a wider range of application scenarios.

### SUMMARY

An objective of the present disclosure is to provide a system for controlling a fluid spatial field in a furnace based on a large model, so as to improve prediction precision of the fluid spatial field in the furnace and reduce the calculation time and resource consumption.

In order to achieve the above objective, the present disclosure provides the following solution.

The present disclosure provides a system for controlling a fluid spatial field in a furnace based on a large model, which includes a distributed sensor network, a data acquisition device, a distributed storage device and an edge computing device; where
the distributed sensor network is deployed inside the furnace;
the data acquisition device is connected with the distributed sensor network, the distributed storage device is connected with the data acquisition device, and the distributed storage device is configured to store fluid spatial field data measured by the distributed sensor network;
the edge computing device is configured to predict the fluid spatial field in the furnace based on measured fluid spatial field data;
a small prediction model and a large modification model are deployed on the edge computing device, the small prediction model is configured to preliminarily predict the fluid spatial field in the furnace based on the measured fluid spatial field data to obtain preliminarily predicted fluid spatial field data; and the large modification model is configured to modify the preliminarily predicted fluid spatial field data to obtain predicted fluid spatial field data, and control the fluid spatial field in the furnace according to the predicted fluid spatial field data.

According to the specific embodiment provided by the present disclosure, the present disclosure has the following technical effects.

The present disclosure provides a system for controlling a fluid spatial field in a furnace based on a large model. The system is provided with a distributed sensor network, a data acquisition device, a distributed storage device and an edge computing device. A small prediction model and a large modification model are deployed on the edge computing device, the small prediction model is used for prediction, and the large modification model is used for modification of a prediction result, so that precision and stability of prediction are improved. Prediction of the fluid spatial field in the furnace is completed based on fluid spatial field data measured by a finite number of sensors in the furnace, and control of the fluid spatial field in the furnace is carried out based on the prediction result, so that precision and stability of control of the fluid spatial field in the furnace are ensured.

### BRIEF DESCRIPTION OF THE DRAWINGS

In order to more clearly explain the technical solution in the embodiments of the present disclosure or the prior art, the drawings needed to be used in the embodiments will be briefly introduced below. Obviously, the drawings described below are only some embodiments of the present disclosure. For those skilled in the art, other drawings can be obtained according to these drawings without paying creative labor.

FIG. 1 is a schematic structural diagram of a system for controlling a fluid spatial field in a furnace based on a large model according to an embodiment of the present disclosure.

FIG. 2 is a schematic structural diagram of an encoded neural network model according to an embodiment of the present disclosure.

FIG. 3 is a flowchart of a method for predicting a fluid spatial field according to an embodiment of the present disclosure.

### DETAILED DESCRIPTION OF THE EMBODIMENTS

The technical solution in the embodiment of the present disclosure will be clearly and completely described below with reference to the drawings in the embodiment of the present disclosure. Obviously, the described embodiments are only some of the embodiment of the present disclosure, rather than all of the embodiments. Based on the embodiments in the present disclosure, all other embodiments obtained by those skilled in the art without paying creative labor belong to the protection scope of the present disclosure.

To make the above objective, the features and the advantages of the present disclosure more obvious and understandable, the present disclosure will be further described in detail with reference to the drawings and the detailed description.

With the continuous development of artificial intelligence technology, the neural network has been widely used in spatial field prediction tasks due to the powerful feature extraction and pattern recognition capabilities. In many studies, an effective prediction model based on data features has been constructed and achieved good application results in many fields. However, most of the existing neural network models are not completely suitable for time series forecasting task of the spatial field. Time series data of the spatial field usually have the features of a high dimension and a large data volume, so that it is easy for the conventional neural network model to face the problems of difficulty in capturing features and non-convergence in training. Because the time series data of the spatial field not only contains a complex spatio-temporal dependence, but also may be affected by factors such as nonlinearity and noise. A conventional model is limited in expressive ability and the generalization ability when dealing with these complex features. Therefore, how to effectively design a model that adapts to high-dimensional and time sequence features has become a major challenge in the current research.

Combining the data dimensionality-reduction compression technology with the neural network method, the problems of a high dimension and a large data volume in prediction of the spatial field time series can be effectively solved. Conventional Proper Orthogonal Decomposition (POD) and Reduced-order Models (ROMs) represent a high dimensionality and a large data volume through a low-dimensional model, and have been widely used in the fields such as fluid mechanics. However, the time series data of the fluid spatial field usually presents complex nonlinear features, which cannot effectively reduce the dimensionality in a linear mapping method. In addition, the training of the ROMs usually needs a large number of sample data, and the time series forecasting of the fluid spatial field involves data in both spatial and temporal scales, so that the conventional training process of the ROMs is more difficult. In contrast, as an unsupervised learning method, the auto-encoder can compress the input data effectively in dimensionality in such a manner that the number of neurons in a hidden layer is less than that neurons in an input layer, thus achieving feature expression and dimensionality reduction. Furthermore, the 3D Convolutional Neural Network (3DCNN) performs well in extracting spatio-temporal features, and can effectively identify the spatial and temporal dependence. Combining the advantages of auto-encoder and the 3DCNN, the method can solve the problem of time series data prediction with a high dimensionality and a large data volume. Through the network hierarchy design, the comprehensive learning of multimodal input data can be achieved, thus improving the prediction precision and the generalization ability of the model.

In order to further improve the precision of the spatial field prediction model, the areas with insufficient data feature learning can be identified by analyzing the empirical data, and then targeted measures are taken. Based on the unsupervised learning ability, the tokenization ability, the emergent ability and the powerful generalization ability of a large language model, a complex multidimensional relationship between data can be effectively dealt with, and the advantage of fusing multimodal information is available. Fine-tuning instructions through language description can flexibly adjust the learning direction of the model, thus improving the generalization ability and precision of prediction. Especially in areas with great differences, the large language model can be used as an auxiliary mechanism to effectively supplement the prediction deficiency of a small model in these areas. The large language model not only can enhance the learning ability of the model by analyzing the relationship between areas, but also optimize the data processing mode of the model in different areas through an adaptive adjustment mechanism, thus achieving more accurate time series forecasting. In this process, the emergent features of the language model can automatically generate an adaptive reasoning path when facing complex and dynamically changing fluid data, and provide a more accurate and reliable solution for spatial field prediction.

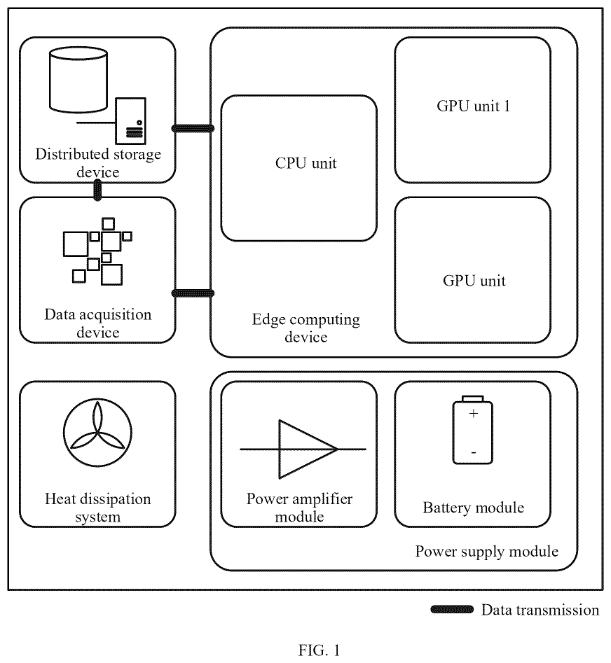

In an exemplary embodiment, as shown in FIG. 1, a system for controlling a fluid spatial field in a furnace based on a large model is provided, which includes a distributed sensor network, a data acquisition device, a distributed storage device and an edge computing device; where the distributed sensor network is deployed inside the furnace; the data acquisition device is connected with the distributed sensor network, the distributed storage device is connected with the data acquisition device, and the distributed storage device is configured to store fluid spatial field data measured by the distributed sensor network; the edge computing device is configured to predict the fluid spatial field in the furnace based on the measured fluid spatial field data; a small prediction model and a large modification model are deployed on the edge computing device, the small prediction model is configured to preliminarily predict the fluid spatial field in the furnace based on the measured fluid spatial field data to obtain preliminarily predicted fluid spatial field data; and the large modification model is configured to modify the preliminarily predicted fluid spatial field data to obtain predicted fluid spatial field data, and control the fluid spatial field in the furnace according to the predicted fluid spatial field data.

In another exemplary embodiment, the edge computing device includes a Central Processing Unit (CPU) and two Graphics Processing Units (GPU); the CPU is connected with the distributed storage device, and the CPU is further connected with the two GPUs; the CPU is configured to process the measured fluid spatial field data, one of the GPUs is deployed with the small prediction model, and the other GPU is deployed with the large modification model; the distributed storage device includes a relational database and a non-relational database, the relational database is configured to store structured numeric data, and the non-relational database is configured to store unstructured or semi-structured graphic data and/or log data.

In another exemplary embodiment, the system for controlling the fluid spatial field in the furnace based on the large model further includes a power supply module and a heat dissipation system; the power supply module is connected with the data acquisition device, the distributed storage device and the edge computing device, and the power supply module is configured to supply power to the data acquisition device, the distributed storage device and the edge computing device; and the heat dissipation system is configured to dissipate heat from the power supply module and the edge computing device.

In the above device embodiment, in order to improve the real-time prediction ability and the system stability of the large modification model, a comprehensive hardware architecture is proposed, which involves the cooperative work of sensors with the data acquisition hardware, the storage system, the adaptive computing unit and the edge computing device. First, the system uses the distributed sensor network to acquire the key physical quantity data inside the furnace and from external inputs in real time. Sensors are arranged in various areas of the furnace to ensure comprehensive and efficient acquisition of key data. The data is transmitted to the central system through a highly reliable communication protocol to ensure the stability of the data transmission process. In order to process and store large-scale historical data and acquire data in real time, the embodiment of the present disclosure designs an efficient distributed storage device, and combines relational and non-relational database systems for data management and optimized access. The relational database (RDBMS) is based on the conventional relational model. Data is organized in the form of rows and columns, and tables are associated by foreign keys, which is suitable for storing structured numerical data. The non-relational database (NoSQL) supports a flexible data model without requiring a strict table structure, and is suitable for storing unstructured or semi-structured data such as graphic data and log data.

In terms of computing processing, the embodiment of the present disclosure is provided with an adaptive computing unit in the edge computing device, which can dynamically adjust computing resources according to different computing requirements to support real-time reasoning and prediction tasks of a large-scale combustion model.

For example, a small prediction model can be deployed on the CPU, while a complex large modification model can be accelerated by the GPU. In the embodiment of the present disclosure, the data acquisition of the prediction model comes from sensors, and the implementation of prediction needs to store data in a memory. Then, a hardware box needs to include a CPU and a GPU, in which the small model is on the CPU and the large model is on the GPU. The whole device is referred to as an edge computing device, and is deployed on site for prediction according to real-time incoming data.

For another example, the embodiment of the present disclosure can also be provided with structures of a CPU and two GPUs, one of which deploys a small model for preliminary prediction of the spatial field, and the other of which deploys a large modification model for key areas (a furnace core, and an air and coal injection area). The edge computing device plays a vital role in the system. Due to deployment on site, the data transmission delay is reduced, the real-time data processing and rapid prediction are achieved, and the operation control of the furnace is optimized.

In another exemplary embodiment, the system for controlling the fluid spatial field in the furnace based on the large model further includes a central computing unit; the central computing unit is configured to train an encoded neural network model to obtain a small prediction model, and construct a large modification model based on a Qwen large model;
where in terms of training an encoded neural network model to obtain a small prediction model, the central computing unit is specifically configured to perform the following step 101 to step 105.

In step 101, the fluid spatial field in the furnace is simulated by using Ansys software, and the fluid spatial field data of each time step from an initial simulation moment to a fluid stable state is obtained.

In step 102, the fluid spatial field data of each time step from the initial simulation moment to the fluid stable state is preprocessed, the preprocessed fluid spatial field data of each time step from the initial simulation moment to the fluid stable state is obtained, and a fluid spatial field data sequence is constructed.

In step 103, the fluid spatial field data sequence is divided by using a sliding window mode to construct a training set.

In step 104, a loss function is constructed.

In step 105, the encoded neural network model is trained by using the training set and the loss function to obtain a trained encoded neural network model as the small prediction model.

Through the close cooperation between the edge computing device and the central computing unit, the device can efficiently complete model reasoning and parameter adjustment, and ensure the real-time acquisition and processing of internal data and working condition parameters. This hardware architecture design not only effectively supports the efficient operation of the spatial prediction model, but also ensures the low delay and high precision of data processing, which greatly improves the real-time prediction ability and the system stability of the combustion large model.

Taking the configuration of two GPUs as an example, the working process of the system for controlling the fluid spatial field in the furnace based on the large model is explained below.

First, the physical quantity data with coordinate information acquired from simulation software or sensors is acquired by a data acquisition device and stored in a data storage module. The embodiment of the present disclosure designs an efficient distributed storage device, and combines relational and non-relational database systems for data management and optimized access. The relational database (RDBMS) is based on the conventional relational model. Data is organized in the form of rows and columns, and tables are associated by foreign keys, which is suitable for storing structured numeric data. The non-relational database (NoSQL) supports a flexible data model without requiring a strict table structure, and is suitable for storing unstructured or semi-structured data such as graphic data and log data. After that, the computing unit module reads the memory data, and processes the change from an irregular grid to a regular grid on the CPU. The prediction model can be accelerated by using the GPU. The embodiment uses a structure of two GPUs, one of which deploys a small model for preliminary prediction of the spatial field, and the other of which deploys a large modification model for key areas (a furnace core, and an air and coal injection area). The adaptive computing unit provided in the embodiment of the present disclosure can dynamically adjust the computing resources according to different computing requirements to support real-time reasoning and prediction tasks of a large-scale combustion model. The prediction results obtained from the computing unit are then sent to the memory for subsequent multi-step prediction or analysis. In addition, the configuration of the battery module and the power amplifier module in the power supply system can be responsible for the power supply management of the device, ensure the stable operation of calculation of the GPU and the CPU, and prevent the interruption of calculation. The device is provided with a heat dissipation system, so as to relieve a large amount of heat generated by the GPU, the CPU and the power supply module, maintain the stable operation of hardware, and avoid the loss of the service life of the device.

The whole system for controlling the fluid spatial field in the furnace based on the large model can be deployed on site and can carry out prediction according to the real-time incoming data. The main module requirements are shown in the following table:

TABLE 1
System Parameter Requirements

| Module | Requirements |
|---|---|
| Power supply | Above 1000 W |
| module | |
| Battery module | Uninterruptible |
| | power supply |
| | with |
| | power |
| | above 1500 |
| | VA |
| Data | Supporting |
| transmission | PCIe |
| module | (Peripheral |
| | Component |
| | Interconnect |
| | Express) |
| Heat dissipation | Air cooling |
| system | |
| CPU | Example of |
| | sufficient data |
| | processing |
| GPU | Two GPUs, |
| | which can |
| | guarantee the |
| | computility of |
| | a large model |
| Main board | Supporting |
| | PCIe |

In another exemplary embodiment of the present disclosure, a three-dimensional space model of the furnace is constructed based on Ansys software, and an irregular grid is generated. According to different working conditions, different boundary conditions are set, dynamic simulation is carried out, and fluid parameter data is acquired during a plurality of steps from the initial simulation moment to the fluid stable state. These data are recorded by means of layer-by-layer sectional extraction in Z axis, and the grid information and the fluid parameter information are stored in a CSV file format, which is convenient for subsequent data processing and analysis.

The temporal dependency degree between fluid time sequence data is quantified by calculating the temporal mutual information I(Xₜ_{₀},Xₜ_{₀}₋ₖ_{₀}), where Xₜ_{₀} and Xₜ_{₀}₋ₖ_{₀} denote the fluid spatial field data at the t₀-th time step and the (t₀−k₀)-th time step, respectively. This process can reveal the relationship between fluids at different time steps and provide a basis for modeling time series data. The temporal mutual information can effectively capture the implicit information in the dynamic change of fluid, especially when the fluid behavior has nonlinear and complex time-varying characteristics. The temporal mutual information I(Xₜ_{₀},Xₜ_{₀}₋ₖ_{₀}) is as follows:

I(Xₜ_{₀},Xₜ_{₀}₋ₖ_{₀})=H(Xₜ_{₀})+H(Xₜ_{₀}₋ₖ_{₀})−H(Xₜ_{₀},Xₜ_{₀}₋ₖ_{₀}),

where H(Xₜ_{₀}₋ₖ_{₀}) is the entropy of the fluid spatial field data Xₜ_{₀}₋ₖ_{₀} at the (t₀−k₀)-th time step, H(Xₜ_{₀},Xₜ_{₀}₋ₖ_{₀}) is the cross entropy between the fluid spatial field data Xₜ_{₀} at the t₀-th time step and the fluid spatial field data Xₜ_{₀}₋ₖ_{₀} at the (t₀−k₀)-th time step, and H(Xₜ_{₀}) is the entropy of the fluid spatial field data Xₜ_{₀} at the t₀-th time step, that is, the data distribution of the fluid at the t₀-th time step. The formula is as follows:

$$H ( {X}_{{t}_{0}} ) = - {\sum }_{{x}_{{t}_{0}} ∈ {X}_{{t}_{0}}} p ( {x}_{{t}_{0}} ) log p ( {x}_{{t}_{0}} ) ,$$

where p(xₜ_{₀}) is the probability distribution of xₜ_{₀} in the fluid spatial field data Xₜ_{₀} at the t₀-th time step.

According to the calculated temporal dependency degree, the data is re-organized. Assuming that the temporal dependency degree is k, the data needs to be sorted according to the following format: input data Xᵢ=(Dᵢ, Dᵢ₊₁, . . . , Dᵢ₊ₖ₋₁) and label Yᵢ=(Dᵢ₊ₖ) of the training sample in the training set, where i takes (1, 2, . . . , I), and the relation I+k is the total step size. Through the data organizing method, rich training samples with temporal dependency can be provided for the subsequent deep learning model.

In another exemplary embodiment, because spatial fluid data is usually high-dimensional, large-scale and complex, in order to improve the training efficiency and precision of subsequent prediction models, data must be effectively compressed. Considering that the grid generated by Ansys software is irregular, the irregular grid data and fluid parameter data are mapped one-to-one into a regular cubic grid by using a point mapping method to ensure the consistency and adaptability of the data. Assume that the shape of the cube grid is (Ax,Ay,Az), which represents the cube grid size in three-dimensional space. Through this mapping method, high-dimensional and complex fluid data can be transformed into a unified format suitable for inputting a deep learning model.

In the grids generated by Ansys software, there are usually many grids in the boundary area, which improves the prediction precision of the boundary area, but also leads to the lower grid density in the central area, thereby affecting the prediction performance of the model in the central area. Therefore, a strategy must be introduced to balance the attentions of the boundary and the central area. Specifically, the Euclidean distance from the central area can be defined, the distance from each grid point to the central area is calculated, and different weights are assigned to each area in the training process according to this distance. By adding the weight linearly related to the distance to the loss function of the prediction model, the attention of the model to each area, especially to the central area, can be effectively adjusted, thus optimizing the overall prediction effect. These distance information will also be mapped into the regular cube grid to ensure the consistency of the data. The calculation formula of the Euclidean distance is as follows:

dₘ=\sqrt{(xₘ−x_{c})²+(yₘ−y_{c})²+(zₘ+z_{c})²}

where dₘ is an Euclidean distance between the m-th grid point of the fluid spatial field and a center point of the fluid spatial field, α and β are coefficients of a linear relationship, xₘ, yₘ and zₘ are x-axis, y-axis and z-axis coordinates of the m-th grid point of the fluid spatial field, and x_{c}, y_{c} and z_{c} are x-axis, y-axis and z-axis coordinates of the center point of the fluid spatial field, respectively.

The weight of the linear relationship is set as wₘ, and the weight which forms a linear relationship with the distance is calculated as follows:

wₘ=α·dₘ+β,

where α and β are coefficients of the linear relationship, and the degree to which the weight changes with the distance is controlled. α adjusts the sensitivity of the weight to the distance, and β is the offset used to adjust the reference level of the weight.

By introducing these weights into the loss function of the model, the importance of different areas in the training process can be adjusted. For example, assuming that the loss function is Lₘ, the weighted loss function L_{w} is as follows:

$${L}_{w} = {\sum }_{m} {w}_{m} \cdot {L}_{m} ,$$

where Lₘ is the loss of an m-th grid point of the fluid spatial field, and wₘ is a linear weight of the m-th grid point of the fluid spatial field.

In order to further improve the computing efficiency and reduce the computing burden of the model, the down-sampling technology can be used to map high-dimensional data to a low-dimensional spatial field (Bₓ,B_{y},B_{z}). The sampling interval R is calculated as follows:

R=A/B,

where A and B denote the resolutions of the original data and the down-sampled data, respectively.

Down-sampling not only can reduce the consumption of computing resources, but also effectively remove noise, highlight the main features of data, and improve the ability of the model to understand the fluid spatial field. This process can ensure that the model can still keep the key fluid dynamic information in the lower-dimensional spatial field, and provide sufficient data support for the subsequent time series forecasting tasks.

In another exemplary embodiment, the small prediction model is obtained by training based on an encoded neural network model. The encoded neural network model uses a high-dimensional cubic grid as input, and dynamically predicts fluid parameters by combining a Three-Dimensional Convolutional Neural Network (3DCNN) and an autoencoder. Specifically, through the combination of a multi-layer 3D convolution layer, residual connection and skip connection, the spatio-temporal features of input spatial data are extracted. The convolution layer is used to capture local features, while residual connection and skip connection are helpful to avoid gradient disappearance in a deep network, thus improving the stability and the performance of the model. The encoding neural network model includes an encoder, a transformer layer and a decoder. The encoder maps the input data to a low-dimensional space, the transformer layer is used as the compression layer of features, and the decoder restores the compressed information.

In order to make the model deal with the prediction of dynamic fluid parameters under different working conditions, it is necessary to consider the influence of working condition parameters on fluid dynamics. Therefore, the working condition parameters are introduced into the transformer layer of the encoded neural network model, and the working condition parameters are fused with the feature vectors extracted by the encoder through concatenating operation. This operation can enhance the adaptability of the model to different working conditions, so that the network can learn the changing law of fluid parameters under various working conditions. The transformer layer combined with the working condition parameters not only plays the role of feature compression, but also can effectively integrate the external working condition information into the time series forecasting of the spatial field, thus improving the generalization ability of the model in practical application.

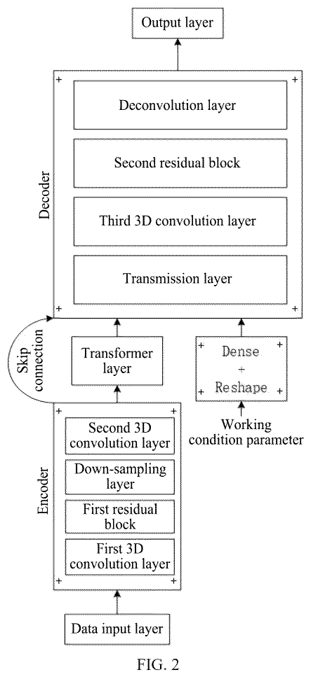

As shown in FIG. 2, the encoded neural network model of the embodiment of the present disclosure includes a data input layer, a working condition parameter input layer, an encoder, a transformer layer, a decoder and an output layer. The data input layer, the encoder, the transformer layer, the decoder and the output layer are connected in sequence. The encoder and the decoder are further connected in a skip connection method. The working condition parameter input layer is connected with the decoder.

The encoder includes a first 3D convolution layer, a first residual block, a down-sampling layer and a second 3D convolution layer which are connected in sequence. The decoder includes a transmission layer, a third 3D convolution layer, a second residual block and a deconvolution layer which are connected in sequence.

The small prediction model used in the present disclosure combines the Three-Dimensional Convolutional Neural Network (3DCNN) and an autoencoder model with a transformer-structure, which is the encoded neural network model. The spatial field data with the shape of (D₁, D₁, D₁, N) and the working condition parameters with the shape of (N_{c}, 1) at a plurality of moments after the regularized grid processing are input. The features of the model are extracted by the encoder, and the features are changed by the transformer layer, and finally the prediction result is restored by the decoder.

The shape of data input by the data input layer is spatial field data of (D₁, D₁, D₁, N), and the shape of data input by the working condition parameter input layer is (N_{c}, 1), where D₁ is the dimension information of the regular grid, and N denotes the data of N historical moments.

For the encoder part, two 3D convolution layers are used for preliminary feature learning and extraction. The residual block includes 12 residual units, and each residual unit includes two layers of 3D convolution. The features are summed by skip connection to keep the input and output dimensions consistent.

In down-sampling layer, the data dimension is gradually reduced by three sampling blocks, each down-sampling block reduces the spatial size by convolution operation, and the final output low-dimensional shape being (D₂, D₂, D₂, N_{M}).

The working condition parameter input layer expands the working condition parameter with the shape of (N_{c}, 1) to (D₂, D₂, D₂, N_{M}) through the fully connected layer, and the expanded working condition parameter is concatenated with the feature map of the output of the encoder to influence the output of the decoder.

The transmission layer transforms data obtained by concatenating the output of the encoder with the working condition parameter through a multi-head attention mechanism.

In decoder part, the output of the encoder is up-sampled through a deconvolution layer, and the spatial resolution of data is gradually restored. The decoder restores the shape of the data to the size of the final (D₁, D₁, D₁, 1) through the deconvolution layer, that is, the next spatial field data is predicted.

As shown in FIG. 2, the “+” sign indicates the residual connection, which indicates that the input and the output which has been subjected to layer operation are added, the arrow indicates the data flow direction. A part of the output of the encoder is connected to the decoder by skip connection.

The calculation formula of convolution and pooling layers in the 3D convolution layer in the small prediction model is as follows:

Yₗ=Conv3D(Xₗ₋₁,Wₗ,bₗ),

Yₗ^{pool}=MaxPool3D(Yₗ),

where Xₗ₋₁ is the output of the (l−1)-th layer, Wₗ is a convolution kernel of the l-th layer, bₗ is a bias term of the l-th layer, Conv3D is a three-dimensional convolution operation, and MaxPool3D is a pooling operation. Through multiple convolution and pooling stacking, a group of low-rank representations ZCNN with spatio-temporal features is obtained, which contains deep features of the spatial fluid field.

The structures of the encoder, the transformer layer and the decoder are shown as follows:

Z_{encoder}=ƒ_{encoder}(Z_{CNN}),

Z_{bottleneck}=ƒ_{bottleneck}(Z_{encode}),

Ŷ=ƒ_{decoder}(Z_{bottleneck}),

where Z_{encoder} is a low-dimensional space mapped by Z_{CNN}, ƒ_{encoder}( ) is an encoding function of the encoder, Z_{CNN} is the output of the data input layer, Z_{bottleneck} is a compressed representation of the transformer layer, ƒ_{bottleneck}( ) is a compressed function of the transformer layer, Ŷ is a prediction result, and ƒ_{decoder}( ) is a decoding function of the decoder.

In order to further improve the adaptability of the model under different working conditions, the working condition parameter P can be combined into the representation of the transformer layer. Through the concatenating operation, the working condition parameter is fused with the features of the transformer layer, and the formula is as follows:

Z_{bottleneck,combined}=Concat(Z_{bottleneck},P),

where Concat is a concatenating function, and Z_{bottleneck,combined} is a fusion feature of the working condition parameter and the compressed representation of the transformer layer.

The final model output Y is

Y=ƒ_{final}(Z_{bottleneck,combined}).

Y is a prediction result, ƒ_{final}( ) is a decoding and prediction function.

In the embodiment of the present disclosure, in order to further improve the prediction precision of the model, skip connection and residual block can be added in the network design, which are helpful to better transmit the feature information, slow down the attenuation of the information in the deep network, and enable the model to better capture the important features in the long time sequence data. In the model training process, the network will carry out reverse propagation based on historical data under different working conditions, thus learning the influence mechanism of different working conditions on the fluid field, and then predicting the fluid state in the future moment.

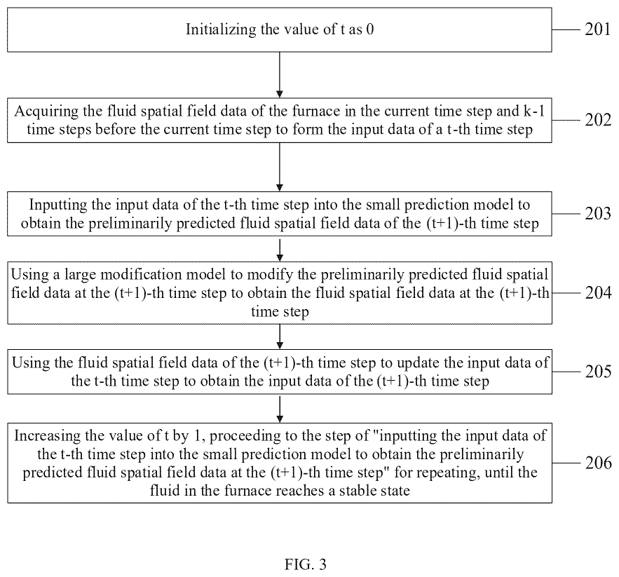

In an exemplary embodiment, as shown in FIG. 3, in terms of predicting the fluid spatial field in the furnace based on the measured fluid spatial field data, the edge computing device is specifically configured to perform the following step 201 to step 206.

In step 201, the value of t is initialized to 0.

In step 202, the fluid spatial field data of the furnace at the current time step and k−1 time steps before the current time step are acquired to form the input data of a t-th time step; and k denotes the temporal dependency degree.

In step 203, the input data of the t-th time step is input into the small prediction model to obtain the preliminarily predicted fluid spatial field data of the (t+1)-th time step.

In step 204, a large modification model is used to modify the preliminarily predicted fluid spatial field data at the (t+1)-th time step to obtain the fluid spatial field data at the (t+1)-th time step.

In step 205, the fluid spatial field data of the (t+1)-th time step is used to update the input data of the t-th time step to obtain the input data of the (t+1)-th time step.

In step 206, increasing the value of t by 1, proceeding to the step of “inputting the input data of the t-th time step into the small prediction model to obtain the preliminarily predicted fluid spatial field data at the (t+1)-th time step” for repeating, until the fluid in the furnace reaches a stable state.

By implementing the above step 201 to step 206, the prediction precision of the fluid spatial field can be improved, and the calculation time and resource consumption can be reduced.

In another exemplary embodiment, the method of acquiring the fluid spatial field data of the furnace at the current time step and k−1 time steps before the current time step in the above step 202 is measured and/or simulated.

In another exemplary embodiment, after obtaining the spatial field data predicted by the small prediction model, these data will be input into the large language model based on Qwen for further modification. Because the spatial field data is usually numerical data, and the input of the Qwen model is character data, when these values are input into Qwen model, the model may disassemble each value into a single character for processing. This operation may lead to insufficient learning of the input data by the model, and then lead to instability or divergence of training. Therefore, the input values must be properly transformed to be compatible with the input format of the Qwen model.

In order to solve this problem, the method of mapping the numerical value to a special Token is used. The Qwen model has extensible Token bits ranging from <|extra_0|> to <|extra_204|>, which can be used to represent different numerical values or numerical ranges. Because the number of Tokens in Qwen is limited, directly mapping all the values may lead to too many Tokens and increase the complexity of training. Therefore, it is necessary to divide the values into a plurality of intervals and map each interval to a corresponding Token. Specifically, by designing an appropriate interval division method, a continuous numerical space can be mapped to these special Tokens, thus reducing the number of Tokens fed into the large model while keeping the effective information of the numerical values. Assume that the input spatial field data is S={s₁,s₂, . . . , s_{J}}, where sⱼ∈R denotes a j-th data point (such as the temperature and the pressure). Assume that the numerical range [sₘᵢₙ,sₘₐₓ] of the fluid spatial field data is divided into N intervals, each interval corresponds to a Token Tₙ, and the mapping function MAP( ) is:

Tₙ=Map(sⱼ)=└(sⱼ−sₘᵢₙ)/Δs┘+1,

where (sₘₐₓ−sₘᵢₙ)/N is the size of each interval, and └⋅┘ denotes the rounding operation.

This mapping method not only solves the problem of format mismatch between numerical input and Qwen character input, but also effectively reduces the number of Tokens and improves the training efficiency of a large model. By optimizing the mapping strategy and the number of Tokens and being combined with the data of the training set, the network is further fine-tuned and modified, so that the precision of the prediction results has been significantly improved. In this process, the Qwen model can fully learn the complex relationship between the numerical value and the spatial field, and improve the generalization ability and precision of the spatial field prediction tasks.

In the above step 206, after the preliminary prediction results of the spatial field data are obtained through the small prediction model, these data will be input into the large modification model for further modification, and the spatial field prediction at the next moment may be generated. Then, the obtained new spatial field data will form a new input together with the previous historical data. By sliding the window, the whole window slides backwards to incorporate a previous prediction value into the input, so as to carry out prediction for the next moment, and modification is performed by the large modification model again. This iterative prediction mechanism enables the model to continuously perform efficient prediction and modification with the constantly updated time series, thus continuously refining the spatial field data in the future moment.

Assume that the initial spatial field prediction data Yₜ obtained from the small model is sent to the large modification model to obtain the modified result Ŷₜ. The calculation formula is as follows:

Ŷₜ=M(Yₜ,θ),

where M is a map function of the large model, and θ is a parameter of the large model.

After each prediction, the new prediction results are added to the history to form new input data, and the updated input data Xₜ₊₁ contains the latest prediction data and previous historical data:

Xₜ₊₁={Ŷₜ,Yₜ₋₁, . . . Yₜ₋ₖ₊₁}.

The iterative process can continue until the set required step size is reached.

Compared with conventional numerical simulation methods, iterative prediction mechanism has obvious advantages in computing efficiency and resource consumption. The conventional numerical simulation methods usually need to solve the whole fluid spatial field step by step, involving complex equations and a large amount of calculation. Especially in the face of high-dimensional spatio-temporal data, the demand for calculation time and resources is extremely huge. Using an iterative prediction mechanism, historical data and prediction results are updated step by step, so as to effectively reduce the dependence on global computing and greatly save computing resources and time overhead.

In addition, the iterative prediction mechanism can modify and optimize the prediction results at each time step, thus improving precision and stability of prediction. Each iteration not only uses the previous historical data, but also takes the prediction result of the previous moment as input, forming a closed-loop updating process. This method enables the prediction model to flexibly adapt to the dynamically changing working conditions, gradually approach the real fluid dynamic features, accumulate experience and adjust strategies in each iteration, and improve the precision and reliability of the prediction results.

In another exemplary embodiment, in order to explain the technical effect of the above control system, the following specific application is provided.

Taking the prediction of the dynamic combusting spatial temperature field in the furnace as an implementation, the effectiveness of the prediction large model of the proposed three-dimensional spatial field is tested. In the embodiment of the present disclosure, in the application of the furnace, the fluid spatial field can be a space temperature field or an air velocity field. In the embodiment of the present disclosure, a space temperature field is taken as an example for description. The control system for the present disclosure can be applied not only to the control of the fluid spatial field in the furnace, but also to the control of the fluid spatial field in other spaces, which will not be described in detail here.

The length, width and height of a boiler model constructed by Ansys software are 24 m, 55.8 m and 16 m, respectively, and the number of grids is up to 1,885,691. The boundary conditions of the model include a speed of primary air, a speed of secondary air, a speed of overfire air, the coal feeding amount and the rate. By changing different boundary conditions for simulation, the boiler temperature is adjusted to 1000K to ignite coal from the beginning of pulverized coal injection to the stable process, and the temperature field data of each step from ignition to the combustion stable state is derived in sequence, and finally a data set of 70 working conditions is generated. In order to further analyze the correlation of temperature field time sequence data, the temporal mutual information of these data is calculated. Through this process, the influence law of the temperature field data of five historical moments on the data of the next moment can be identified, and these data is organized into a training set, which contains the temporal field data of five moments as the input and the temperature field data of the next moment as the label, providing a basis for the subsequent prediction model training.

Because of the overall structural features of grid data, the fluid spatial field is mapped into 48×48×48 cube data one by one. In order to reduce the data dimension and improve the calculation efficiency, the fluid spatial field is further mapped to 36×36×36 cube data by a down-sampling method. According to the specific size of the boiler, the position of the center line is first determined. Then, the Euclidean distance from all grid points to the center line is calculated, and the weight is calculated according to this distance, and mapped to the 48×48×48 cube data. Finally, the 48×48×48 cube data with weight information is further compressed into 36×36×36 cube data by a down-sampling method, which is convenient for subsequent model input and training.

80% of data in all simulation data sets are used as a training set, 14% of data as a test set, and 6% of data as a verification set. The prediction large model of the spatial field is trained and predicted by the training set, and the whole process is divided into the following steps.

Training and prediction of small prediction model: the input data is the regular cube data of five historical moments with the shape of 36×36×36×5, and the working condition parameter data with the shape of 5×1 needs to be input in the transformer layer. By concatenating these data in the transformer layer, the data are finally transmitted to the three-dimensional Convolutional Neural Network (3DCNN) and the autoencoder for processing. The spatial temperature field data in the future moment is predicted and output with the shape of 36×36×36×1. In the training process, the spatial points are allocated by using the Euclidean distance weight function saved above as the weighted term of the loss function. The weight function can effectively balance the training focus of the boundary area and the central area, and avoid the over-fitting of the boundary area.

Because there are only 205 special token extension positions of the Qwen model, that is, from <|extra_0|> to <|extra_204|>, a special token position is allocated every 10K to the temperature field ranging from 0 to 2000K, and the temperature data is mapped into the corresponding token representation. These tokens may be used as identifiers of numerical data. By mapping the output data of each small prediction model to the corresponding real temperature field data, the internal network of the large model can be fine-tuned to gradually modify the prediction results of the large model and make it closer to the real data. After obtaining the fine-tuned large modification model, the temperature field data generated by of the small prediction model at each step can be further modified. By using the large model as the adjustment network, the output results can be manually adjusted by using a prompter project in real time, and the adjusted results can be saved in the historical data, thus providing users with more accurate and demand-oriented prediction results.

By applying the iterative prediction mechanism, the temperature field data of the next state space generated by the small prediction model and the large modification model are adjusted as a training set. With the advancement of the sliding window, continue to train and predict the next state. In the training process, layer-by-layer mapping and up-sampling techniques are used to restore the prediction results from 36×36×36 cube data to 48×48×48 grid data, so as to conform to the grid structure and provide a higher spatial resolution.

In this experiment, five-step dynamic temperature field changes are predicted continuously for a certain working condition. Through the results of the multi-step prediction temperature field, the relative error of the overall spatial field temperature is obtained, in which the relative error of the highest value is about 4%, the relative error of the lowest value is about 17.83%, and the relative error of the average temperature of all grid points is about 2%. The errors of 78% of prediction points fall within the error band of 0-25%, which can effectively deduce the combustion change and ensure high prediction accuracy. The errors are mainly concentrated in the area with a large temperature gradient change (such as the nozzle area), while the error in other areas is controlled within 25%.

Compared with Ansys simulation, the calculation speed of the large model based on the spatial field prediction is improved by 98.3%. Specifically, the Ansys simulation takes about 1 second in each calculation step, while the large model prediction takes only 17 milliseconds, which greatly improves the prediction efficiency and real-time performance.

In order to accurately monitor the operation state and the combustion process of the boiler furnace, the embodiment of the present disclosure uses a distributed sensor network to acquire the key physical quantity data in the boiler and input from the outside in real time. These sensors cover all areas of the boiler furnace and acquire multi-dimensional data such as a furnace temperature, a flue gas velocity and a pressure, including key parameters such as primary air, secondary air, air speed of overfire air and coal supply. Each sensor module is individually configured according to its physical location and measurement requirements, and the acquired data is transmitted to the central processing unit through a stable communication protocol. Aiming at the large-scale data generated in the combustion process of the boiler furnace, this system designs an efficient distributed storage architecture to ensure the efficient storage of historical data and data acquired in real time. The system combines the relational database and the non-relational database. The relational database is used to store structured numerical data (such as the temperature and the pressure) generated in the boiler operation process, while the non-relational database is used to store unstructured data such as sensor data, combustion process logs and boiler combustion images.

In order to support the real-time reasoning and prediction of large-scale models, this system is provided with an adaptive computing unit. The adaptive computing unit dynamically adjusts the computing resources according to the computing complexity and real-time requirements of tasks, so as to ensure that the system can efficiently process different types of computing tasks. For example, a small prediction model (such as the preliminary prediction of the combustion temperature field) can be deployed and run on a low-power CPU, while a large modification model (such as a grid with a large modification error) involving complex operation is accelerated by the GPU. In addition, the edge computing device plays a vital role in this system. By deploying edge computing nodes on the boiler site, the edge computing device can reduce data transmission delay and ensure real-time data processing and real-time feedback. The edge computing device not only can preprocess local data, but also perform tasks such as model reasoning and adjusting control parameters, and quickly respond to changes in boiler operation. Through the cooperation of the edge computing unit and the central computing unit, the system achieves low delay and high precision of data acquisition and processing.

According to the specific embodiment provided by the present disclosure, the present disclosure has the following technical effects.
1. The system for controlling the fluid spatial field in the furnace of the present disclosure is based on the small prediction model and the large modification model, which can significantly reduce the calculation time while ensuring high precision. Through the effective compression of grid data, the joint prediction of the small prediction model and the large modification model, and the design of the iterative prediction mechanism, these models comprehensively capture the complex relationship between working condition parameters and historical spatial field data, thus ensuring the precision of prediction results. In addition, the model can reproduce the spatial field data in about 10 milliseconds. Compared with the conventional numerical calculation method, the calculation time is greatly shortened, and the prediction efficiency and real-time performance are significantly improved.
2. The mode of introducing the large language model into the prediction model proposed in the present disclosure makes full use of the emergent ability of the large language model and achieves the efficient training and reasoning process. This method can modify the areas with insufficient precision in the early small prediction model in time, and further optimize the model performance through the guidance of prompters in the training process. In this way, these models not only can improve the precision adaptively, but also effectively deal with complex multi-modal data input, and enhance the robustness and generalization ability of the overall prediction system.
3. The small prediction model and the large modification model proposed in the present disclosure have high expansibility and strong generalization ability. The model can be applied to other similar models after the encoder part of the auto encoder learns the spatiotemporal feature of the historical data of the spatial field. By adjusting the boundary conditions, the transformer layer of the small prediction model and the decoder part of the auto encoder can be retrained, and the pre-trained large language model is fine-tuned without modifying the global parameters. This flexible manner enables the model to adapt to the spatial field learning tasks of different working conditions and different types, thus improving the applicability and precision in various application scenarios.

The technical features of the above embodiments can be combined at will. In order to make the description concise, not all possible combinations of the technical features in the above embodiments are described. However, as long as there is no contradiction between the combinations of these technical features, the combinations should be considered as the scope recorded in this specification.

In the present disclosure, specific examples are used to explain the principle and implementation of the present disclosure, and the description of the above embodiments is only used to help understand the method and the core idea of the present disclosure. At the same time, for those skilled in the art, according to the idea of the present disclosure, there will be changes in the detailed description and the application scope. In summary, the contents of this specification should not be construed as limiting the present disclosure.

1-10. (canceled)

11. A system for controlling a fluid spatial field in a furnace based on a large model, which comprises a distributed sensor network, a data acquisition device, a distributed storage device and an edge computing device; wherein
the distributed sensor network is deployed inside the furnace;
the data acquisition device is connected with the distributed sensor network, the distributed storage device is connected with the data acquisition device, and the distributed storage device is configured to store fluid spatial field data measured by the distributed sensor network;
the edge computing device is configured to predict the fluid spatial field in the furnace based on measured fluid spatial field data;
a small prediction model and a large modification model are deployed on the edge computing device, the small prediction model is configured to preliminarily predict the fluid spatial field in the furnace based on the measured fluid spatial field data to obtain preliminarily predicted fluid spatial field data; and the large modification model is configured to modify the preliminarily predicted fluid spatial field data to obtain predicted fluid spatial field data, and control the fluid spatial field in the furnace according to the predicted fluid spatial field data;
wherein the system for controlling the fluid spatial field in the furnace based on the large model further comprises a central computing unit;
the central computing unit is configured to train an encoded neural network model to obtain the small prediction model, and construct the large modification model based on a Qwen large model;
wherein in terms of training the encoded neural network model to obtain the small prediction model, the central computing unit is configured to:
simulate the fluid spatial field in the furnace by using Ansys software, and obtain fluid spatial field data of each time step from an initial simulation moment to a fluid stable state;
preprocess the fluid spatial field data for each time step from the initial simulation moment to the fluid stable state, obtain preprocessed fluid spatial field data for each time step from the initial simulation moment to the fluid stable state, and construct a fluid spatial field data sequence;
divide the fluid spatial field data sequence in a sliding window mode to construct a training set;
construct a loss function; and
train the encoded neural network model by using the training set and the loss function to obtain a trained encoded neural network model as the small prediction model.

12. The system for controlling the fluid spatial field in the furnace based on the large model according to claim 11, wherein the edge computing device comprises a Central Processing Unit (CPU) unit and two Graphics Processing Unit (GPU) units; the CPU unit is connected with the distributed storage device, and the CPU unit is further connected with the two GPU units;
the CPU unit is configured to process the measured fluid spatial field data, one of the GPU units is deployed with the small prediction model, and an other GPU unit is deployed with the large modification model;
the distributed storage device comprises a relational database and a non-relational database, the relational database is configured to store structured numerical data, and the non-relational database is configured to store unstructured or semi-structured graphic data and/or log data.

13. The system for controlling the fluid spatial field in the furnace based on the large model according to claim 11, wherein the system for controlling the fluid spatial field in the furnace based on the large model further comprises a power supply module and a heat dissipation system;
the power supply module is connected with the data acquisition device, the distributed storage device and the edge computing device, and the power supply module is configured to supply power to the data acquisition device, the distributed storage device and the edge computing device; and
the heat dissipation system is configured to dissipate heat from the power supply module and the edge computing device.

14. The system for controlling the fluid spatial field in the furnace based on the large model according to claim 11, wherein
a training sample in the training set is: Xᵢ=(Dᵢ, Dᵢ₊₁, . . . , Dᵢ₊ₖ₋₁), and a label of the training sample is Yᵢ=(Dᵢ₊ₖ); Xᵢ is an i-th training sample; Yᵢ is a label of the i-th training sample, Dᵢ, Dᵢ₊₁ and Dᵢ₊ₖ₋₁ are preprocessed fluid spatial field data for the i-th, (i+1)-th and (i+k)-th time steps, respectively, and Dᵢ₊ₖ is preprocessed fluid spatial field data for the (i+k)-th time step;
the loss function is
$${L}_{w} = {\sum }_{m} {w}_{m} \cdot {L}_{m} ;$$
wₘ=α·dₘ+β;
dₘ=\sqrt{(xₘ−x_{c})²+(yₘ−y_{c})²+(zₘ−z_{c})²};
where L_{w} is a loss function, Lₘ is a loss of an m-th grid point of the fluid spatial field, and wₘ is a linear weight of the m-th grid point of the fluid spatial field;
dₘ is an Euclidean distance between the m-th grid point of the fluid spatial field and a center point of the fluid spatial field, α and β are coefficients of a linear relationship, xₘ, yₘ and zₘ are x-axis, y-axis and z-axis coordinates of the m-th grid point of the fluid spatial field, and x_{c}, y_{c} and z_{c} are x-axis, y-axis and z-axis coordinates of the center point of the fluid spatial field, respectively.

15. The system for controlling the fluid spatial field in the furnace based on the large model according to claim 11, wherein processing the fluid spatial field data for each time step from the initial simulation moment to the fluid stable state, and obtaining the preprocessed fluid spatial field data for each time step from the initial simulation moment to the fluid stable state, which specifically comprises:
mapping target fluid spatial field data of an irregular grid into a cubic grid by using a point mapping method to obtain mapped target fluid spatial field data; wherein the target fluid spatial field data is fluid spatial field data at any time step from the initial simulation moment to the fluid stable state;
down-sampling the mapped target fluid spatial field data by using a down-sampling method to obtain preprocessed target fluid spatial field data.

16. The system for controlling the fluid spatial field in the furnace based on the large model according to claim 11, wherein the encoded neural network model comprises a data input layer, a working condition parameter input layer, an encoder, a transformer layer, a decoder and an output layer;
the data input layer, the encoder, the transformer layer, the decoder and the output layer are connected in sequence;
the encoder and the decoder are further connected in a skip connection method;
the working condition parameter input layer is connected with the decoder;
a formula of the encoder is
Z_{encoder}=ƒ_{encoder}(Z_{CNN});
a formula of the transformer layer is:
Z_{bottleneck}=ƒ_{bottleneck}(Z_{encode});
formulas of the decoder are:
Y=ƒ_{final}(Z_{bottleneck,combined});
Z_{bottleneck,combined}=Concat(Z_{bottleneck},P);
wherein Z_{encoder} is a low-dimensional space mapped by Z_{CNN}, ƒ_{encoder}( ) is an encoding function of the encoder, Z_{CNN} is an output of the data input layer, Z_{bottleneck} is a compressed representation of the transformer layer, ƒ_{bottleneck}( ) is a compressed function of the transformer layer, Y is a prediction result, ƒ_{final}( ) is a decoding and prediction function, Z_{bottleneck,combined} is a fusion feature of a working condition parameter and the compressed representation of the transformer layer, Concat( ) is a concatenating function, and P is a working condition parameter.

17. The system for controlling the fluid spatial field in the furnace based on the large model according to claim 16, wherein the encoder comprises a first 3D convolution layer, a first residual block, a down-sampling layer and a second 3D convolution layer which are connected in sequence;
the decoder comprises a transmission layer, a third 3D convolution layer, a second residual block and a deconvolution layer which are connected in sequence.

18. The system for controlling the fluid spatial field in the furnace based on the large model according to claim 11, wherein in terms of predicting the fluid spatial field in the furnace based on the measured fluid spatial field data, the edge computing device is configured to:
initializing a value of t as 0;
acquiring fluid spatial field data of the furnace at the current time step and k−1 time steps immediately before the current time step to form input data of a t-th time step, wherein k denotes a temporal dependency degree;
inputting the input data of the t-th time step into the small prediction model to obtain preliminarily predicted fluid spatial field data for a (t+1)-th time step;
using the large modification model to modify the preliminarily predicted fluid spatial field data for the (t+1)-th time step to obtain fluid spatial field data for the (t+1)-th time step;
using the fluid spatial field data for the (t+1)-th time step to update the input data of the t-th time step to obtain input data for the (t+1)-th time step;
increasing a value of t by 1, proceeding to the “inputting the input data of the t-th time step into the small prediction model to obtain the preliminarily predicted fluid spatial field data of the (t+1)-th time step”, until a fluid in the furnace reaches a stable state.

19. The system for controlling the fluid spatial field in the furnace based on the large model according to claim 18, wherein the temporal dependency degree is acquired by following methods:
assuming that a value of k₀ is 1;
calculating temporal mutual information between fluid spatial field data for a t₀-th time step and fluid spatial field data for a (t₀−k₀)-th time step;
determining whether a formula I(Xₜ_{₀},Xₜ_{₀}₋ₖ_{₀})≥I₀ holds; where I₀ is a temporal mutual information threshold;
increasing the value of k₀ by 1, if holds, and proceeding to step of “calculating temporal mutual information between fluid spatial field data for the t₀-th time step and fluid spatial field data for the (t₀−k₀)-th time step”;
outputting the value of k₀ as the temporal dependency degree, if not;
wherein calculation formula of the temporal mutual information is
I(Xₜ_{₀},Xₜ_{₀}₋ₖ_{₀})=H(Xₜ_{₀})+H(Xₜ_{₀}₋ₖ_{₀})−H(Xₜ_{₀},Xₜ_{₀}₋ₖ_{₀});
where, I(Xₜ_{₀},Xₜ_{₀}₋ₖ_{₀}) is a temporal mutual information between the fluid spatial field data Xₜ_{₀} for the t₀-th time step and the fluid spatial field data Xₜ_{₀}₋ₖ_{₀} for the (t₀−k₀)-th time step, H(Xₜ_{₀}) is an entropy of the fluid spatial field data Xₜ_{₀} for the t₀-th time step, H(Xₜ_{₀}₋ₖ_{₀}) is an entropy of the fluid spatial field data Xₜ_{₀}₋ₖ_{₀} for the (t₀−k₀)-th time step, and H(Xₜ_{₀},Xₜ_{₀}₋ₖ_{₀}) is a cross entropy between the fluid spatial field data Xₜ_{₀} for the t₀-th time step and the fluid spatial field data Xₜ_{₀}₋ₖ_{₀} for the (t₀−k₀)-th time step.
